(19) United States
(12) Patent Application Publication
(10) Pub. No.: US 2011/0141588 A1
(43) Pub. Date: Jun. 16, 2011

(54) OPTICAL DEVICE AND LENS COLLISION PREVENTING METHOD THEREOF

(75) Inventors: Ying Tse Lai, Taichung (TW); Chih Wei Liang, Taichung (TW)

(73) Assignee: ASIA OPTICAL CO., INC., Taichung (TW)

(21) Appl. No.: 12/963,067

(22) Filed: Dec. 8, 2010

(30) Foreign Application Priority Data
Dec. 11, 2009 (TW) 98142440

(51) Int. Cl. G02B 7/02

(52) U.S. Cl. 359/824

(57) ABSTRACT

An optical device includes a lens, a driving unit, a control unit, a frame, and a boundary detecting unit. The lens has a metal barrel. The control unit is electrically connected to the driving unit, to control a movement thereof. The frame has an inner wall. The frame defines a lens movement area. The boundary detecting unit is disposed on the inner wall. The boundary detecting unit has a plurality of sensors disposed on the inner wall, and surrounds the lens equidistantly. When the metal tube approaches one of the sensors, a capacitance of the sensor will be changed, and the IC sends a position detection signal to the control unit, according to the capacitance variation. The control unit controls the movement of the lens, according to the position detection signal.

### BACKGROUND OF THE INVENTION

1. Field of the Invention

The present invention relates generally to an optical device, and more particularly, to an optical device capable of preventing the lens from collision.

2. Description of the Related Art

Taiwan patent publication No. 200905354 discloses an optical device capable of preventing the lens from colliding with the frame by a control unit. The control unit calculates steps of a stepper motor to locate the lens, and compares it with a critical coordinate in a database to verify whether the lens collides with the frame. In the prior art, the cost to build the system of the stepper motor, the control unit, and the database is very high that such optical devices are very expensive. In addition, it involves a complex calculation, in which it needs to slow down the movement of the lenses, to avoid collision due to initial force. It is inconvenient to consumers.

### SUMMARY OF THE INVENTION

The primary objective of the present invention is to provide an optical device, which may overcome the problems of the conventional optical device.

According to the objective of the present invention, an optical device includes a lens having a metal barrel; a driving unit connected to the lens to move the lens; a control unit electrically connected to the driving unit to control a movement of the lens; a frame having an inner wall; and a boundary detecting unit, including an integrated circuit electrically connected to the control unit, and a plurality of sensors mounted on the inner wall of the frame, with a constant interval therebetween, and electrically connected to the integrated circuit. Capacitance of the sensors are changed when the metal barrel of the lens is close to the sensors, and when the integrated circuit sends a position detection signal to the control unit, according to capacitance variations of the sensors, to control the movement of the lens.

With the present invention, it prevents the lens from colliding with the frame by a simple control procedure, a simple calculation, hence, at a lower cost.

### BRIEF DESCRIPTION OF THE DRAWINGS

FIG. 1 is a perspective view of the optical device of a preferred embodiment of the present invention;

FIG. 2 is a block diagram of the optical device of the preferred embodiment of the present invention;

FIG. 3 is a sectional view of the boundary detecting unit of the preferred embodiment of the present invention; and

FIG. 4 is a perspective view of the orientation of the sensor of the preferred embodiment of the present invention.

### DETAILED DESCRIPTION OF THE INVENTION

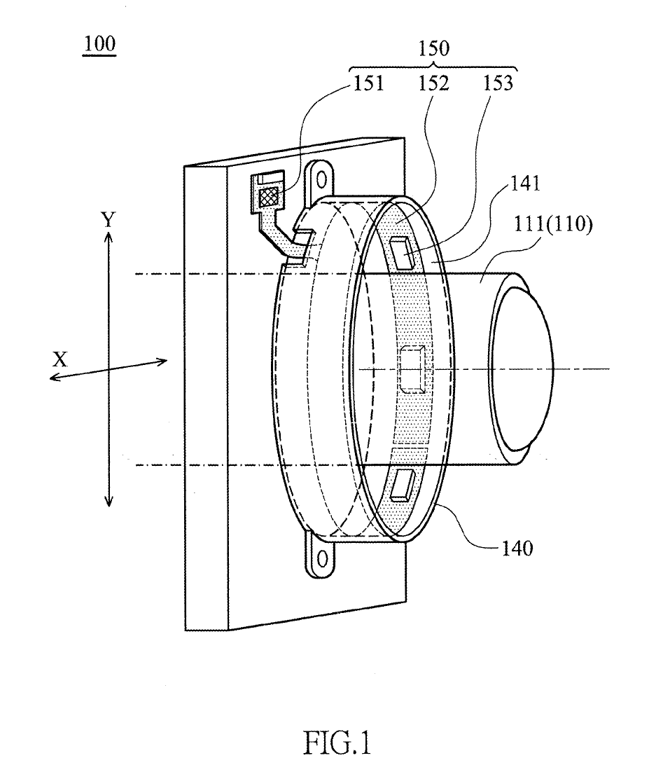

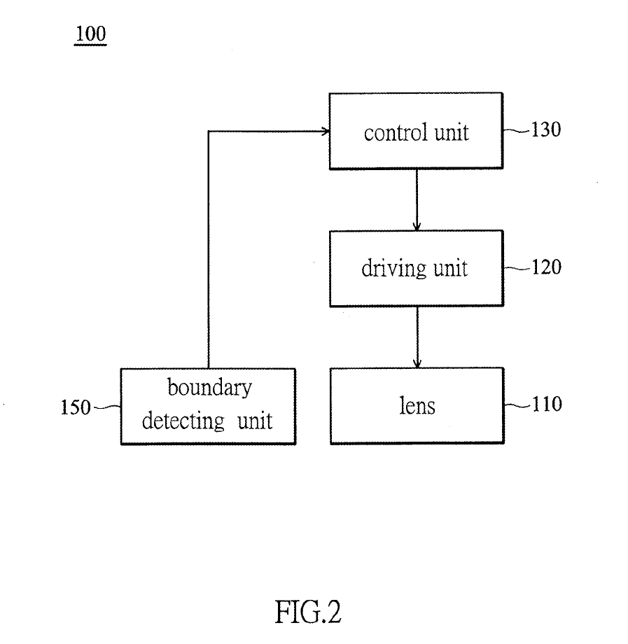

As shown in FIG. 1 and FIG. 2, an optical device 100 of the preferred embodiment of the present invention includes a lens 110, a driving unit 120, a control unit 130, a frame 140, and a boundary detecting unit 150. The lens 110 has a metal barrel 111. The driving unit connects the lens 110 to move the lens 110. The control unit 130 is electrically connected to the driving unit 120, to control a movement of the lens 110. The frame 140 has an inner wall 141 to enclose a lens movement area. The boundary detecting unit 150 is mounted on the inner wall 141 of the frame 140.

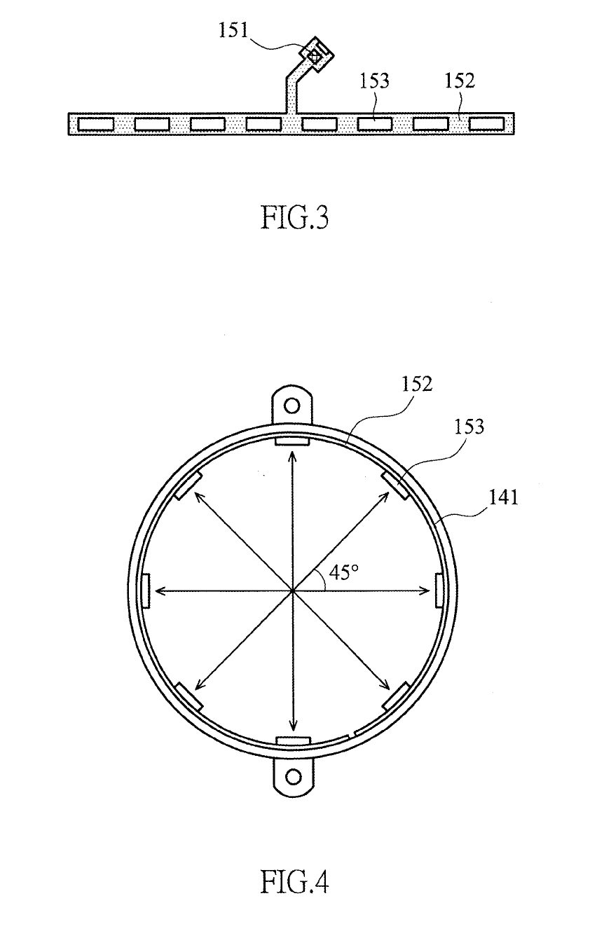

As shown in FIG. 1 and FIG. 3, the boundary detecting unit 150 has an integrated circuit (IC) 151, a flexible circuit board (FCB) 152, and a plurality of sensors 153. The IC is connected to the control unit 130. The sensors 153 are connected to the IC 151 through the FCB 152. The sensors 153 are arranged on the FCB 152 with a constant interval therebetween. In the present invention, the sensors are copper foils, and the IC is a capacitive sensing IC.

As shown in FIG. 1 and FIG. 4, the sensors 153 surround the lens 110 in a constant interval. The FCB 152 is fixed to the inner wall 141 of the frame 140. There are eight sensors 153 in the present invention, and an angle between each two of the neighboring sensors 153, is forty-five degrees. When the metal barrel 111 approaches any one of the sensors 153, electric charges on the sensor 153 will be attracted by the metal barrel 111 to change a capacitance of the sensor 153. The IC 151 sends a position detection signal according to the capacitance variation of the sensor 153, to control a movement of the lens 110. Therefore, the movement of the lens may be precisely controlled according to the boundary detecting unit 150. In practice, the number of the sensors may change according to various conditions, for instance, the number of the sensors may be four.

In the present invention, the frame is round. However, the frame may be square, or other shapes.

The control unit 130 compares the position detection signals from the IC 151 with a critical position value. The position detection signals reach the critical position value, when the metal barrel 111 of the lens 110 is very close to the inner wall 141 of the frame 140, and the control unit 130 control the driving unit 120, to stop the lens 110 or move the lens 110 away from the frame 140.

In conclusion, without a complex calculation, the present invention may prevent the lens from collision, by a simple sensing and control procedure.

The description above is a few preferred embodiments of the present invention, and the equivalence of the present invention is still in the scope of claim construction of the present invention.

What is claimed is:

1. An optical device, comprising:
a lens having a metal barrel;
a driving unit connected to the lens to move the lens;
a control unit electrically connected to the driving unit to control a movement of the lens;
a frame having an inner wall; and
a boundary detecting unit including an integrated circuit electrically connected to the control unit, and a plurality of sensors mounted on the inner wall of the frame with a constant interval therebetween, and electrically connected to the integrated circuit that capacitances of the sensors are changed, when the metal barrel of the lens is close to the sensors, and when the integrated circuit sends a position detection signal to the control unit, according to capacitance variations of the sensors, to control the movement of the lens.

2. The optical device as defined in claim 1, wherein the sensors of the boundary detecting unit are copper foils.

3. The optical device as defined in claim 1, wherein the integrated circuit of the boundary detecting unit is a capacitive sensing integrated circuit.

4. The optical device as defined in claim 1, wherein the boundary detecting unit further includes a flexible circuit board, of which the sensors are provided with the constant interval therebetween that the sensors are electrically connected to the integrated circuit, through the flexible circuit board.

5. The optical device as defined in claim 4, wherein the flexible circuit board is fixed to the inner wall of the frame.

6. The optical device as defined in claim 1, wherein a number of the sensors is four.

7. The optical device as defined in claim 1, wherein a number of the sensors is eight.

8. The optical device as defined in claim 1, wherein the frame is round.

9. The optical device as defined in claim 1, wherein the frame is square.

10. A method of preventing a lens from collision, comprising the steps of:
providing the optical device as defined in claim 1;
comparing the position detection signal with a critical position value; and
controlling the driving unit to limit a movement of the lens when the position detection signal is close to the critical position value.

11. The method as defined in claim 10, wherein the sensors of the boundary detecting unit are copper foils.

12. The method as defined in claim 10, wherein the integrated circuit of the boundary detecting unit is a capacitive sensing integrated circuit.

13. The method as defined in claim 10, wherein the boundary detecting unit further includes a flexible circuit board, of which the sensors are provided with the constant interval therebetween that the sensors are electrically connected to the integrated circuit through the flexible circuit board.

14. The method as defined in claim 13, wherein the flexible circuit board is fixed to the inner wall of the frame.

15. The method as defined in claim 10, wherein a number of the sensors is four.

16. The method as defined in claim 10, wherein a number of the sensors is eight.

17. The method as defined in claim 10, wherein the frame is round.

18. The method as defined in claim 10, wherein the frame is square.
